(19) United States
(12) Patent Application Publication
(10) Pub. No.: US 2013/0106281 A1
(43) Pub. Date: May 2, 2013

(54) HIGH-PRESSURE DISCHARGE LAMP

(71) Applicant: Andreas Genz, Berlin (DE)

(72) Inventor: Andreas Genz, Berlin (DE)

(73) Assignee: OSRAM AG, Muenchen (DE)

(21) Appl. No.: 13/809,190

(22) PCT Filed: Jul. 9, 2010
(86) PCT No.: PCT/EP2010/059861

§ 371 Date: Jan. 9, 2013

(51) Int. Cl. H01J 61/20; H01J 61/72; H01J 61/30

(52) U.S. Cl. CPC H01J 61/20; H01J 61/302; H01J 61/72
USPC 313/572; 313/642; 313/636

(57) ABSTRACT

In various embodiments, a high pressure discharge lamp is provided having a bulb, which surrounds a discharge volume, wherein a filler, which contains indium halide, quicksilver and inert gas from the group neon, argon, krypton, xenon, is accommodated in the discharge volume, wherein the filler simultaneously contains the halide of iodine and bromine, wherein the portion of InI amounts at most to 90 mol %, in respect of the total of all halides of In.

### TECHNICAL FIELD

The invention is based on a high pressure discharge lamp as claimed in the preamble of claim 1. It particularly relates to metal halogen lamps. Such lamps are especially high pressure discharge lamps having a ceramic discharge vessel or quartz glass vessel for general illumination.

### PRIOR ART

DE 101 01 508 discloses a high pressure discharge lamp, in which a metal halide filler is used. The high pressure discharge lamp contains iodide from indium as the metal halide.

### PRESENTATION OF THE INVENTION

It is the object of the present invention to provide a high pressure discharge lamp as claimed in the preamble of claim 1, which provides a colored emission in the blue spectral range in a simple and cost-effective manner.

This object is achieved by the characterizing features of claim 1. Particularly advantageous embodiments are found in the dependent claims.

Colored lamps are gaining increasing market significance as effect light in architectural lighting. The invention relates to blue HQI lamps. There are three aims here: 1. high radiation output in the blue spectral range. 2. high color saturation. 3. good maintenance. Fillers used until now consist of InI.

Surprisingly a filler made of InBr+InI—InCl indicates better maintenance than the previous filler made of InI. The following limit values apply here: the molar portion of InI lies between 40 and 90%. The molar portion of InBr lies between 10 and 60%. The molar portion of InCl lies at a maximum of 20%. The total of the molar portions amounts to 100%. Justification behind the limit values: exceeding the InCl portion of 20% and/or of the InBr portion of 60% results in electrode corrosion, in other words in premature failure. Exceeding the molar InI portion has a negative affect on the maintenance. The fill quantity of the entire In-halide lies between 0.05 and 0.5 mg per ml discharge volume.

As a result, the radiation output in the blue spectral range is increased. The maintenance, in other words the stability of the output emitted in the blue spectral range, is furthermore improved without negatively affecting the other important variable, the color saturation.

The fillers used previously for blue emission normally use InI. The use of a mixture of halides was never seriously considered, since it did not promise any additional advantages, but is more complicated to manufacture since the mixture has to be checked and adjusted.

A filler made of a mixture of various halides of In surprisingly indicates a better maintenance than the previous filler made of InI on the one hand and pure InBr on the other hand.

The following limit values apply here: the portion of InI lies at at least 25% by weight and at most 75% by weight.

The fill quantity of the entire In-halide lies between 0.1 and 1 mg per ml discharge volume. A value between 0.2 and 1.0 mg/ml for lamps in the power range of 35 to 150 W and a value between 0.1 and 0/6 mg/ml for lamps of 175 to 1000 W is particularly preferred.

The inventive concept is above all suited to lamps with a small and average output in the range 15 to 1000 W.

Essential features of the invention in the form of a numbered list are:

1. High pressure discharge lamp with a bulb, which surrounds a discharge volume, wherein a filler, which contains indium halide, quicksilver and inert gas from the group neon, argon, krypton, xenon, is accommodated in the discharge volume, characterized in that the filler simultaneously contains the halide of iodine and bromine, wherein the portion of InI amounts at most to 90 mol %, in respect of the total of all halides of In.

2. High pressure discharge lamp as claimed in claim 1, characterized in that the portion of InI amounts to at least 25%, in particular at least 40%.

3. High pressure discharge lamp as claimed in claim 1, characterized in that the portion of InBr amounts to 10% to a maximum of 60 mol %, in respect of the total of all halides of In.

4. High pressure discharge lamp as claimed in claim 1, characterized in that the filler has portions of InCl to a maximum of 20 mol %, in respect of the total of all halides of In, in particular at least 2 mol %.

5. High pressure discharge lamp as claimed in claim 1, characterized in that the inert gas is argon, xenon, krypton or neon or mixtures thereof.

6. High pressure discharge lamp as claimed in claim 1, characterized in that the cold filling pressure of the inert gas is selected in the range of 30 to 300 hPa.

7. High pressure discharge lamp as claimed in claim 1, characterized in that the content of Hg is selected in the range 3 to 30 mg/cm³.

8. High pressure discharge lamp as claimed in claim 1, characterized in that the lamp is a color-emitting lamp for effect lighting.

9. High pressure discharge lamp as claimed in claim 1, characterized in that the fill quantity of the entire In-halide lies between 0.05 and 0.5 mg per ml discharge volume.

10. High pressure discharge lamp as claimed in claim 1, characterized in that the discharge vessel is manufactured from quartz glass.

### FIGURES

The invention is to be explained in more detail below with the aid of several exemplary embodiments, in which:

FIG. 1 shows a high pressure discharge lamp with a discharge vessel having a separate outer bulb

FIG. 2 shows a high pressure discharge lamp with a discharge vessel having an integrated outer bulb;

FIG. 3 shows a diagram, which indicates the maintenance for various fillers with 70 W lamps.

FIG. 4 shows a diagram, which indicates the maintenance for various fillers with 150 W lamps.

### DESCRIPTION OF THE DRAWINGS

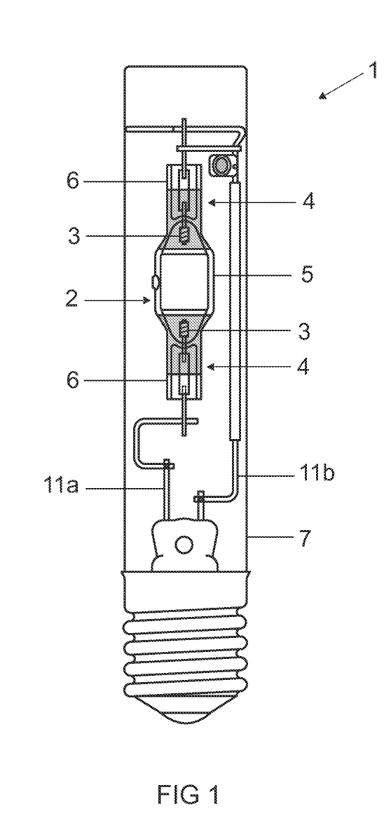

FIG. 1 shows a schematic representation of a metal halide lamp 1. It consists of a discharge vessel 2 made of quartz glass, into which two electrodes 3 are introduced. The discharge vessel has a central part 5 and two ends 4. Located at the ends are two crimped sections 6.

The discharge vessel 2 is surrounded by an outer bulb 7. The discharge vessel 2 is held in the outer bulb by means of a frame, which contains a short and long power supply 11a and 11b.

The discharge vessel contains a filler, which typically includes Hg (3 to 30 mg/cm³) and 0.1 to 1 mg/cm³ of halide of indium. Pressurized argon of 30 to 300 hPa is used cold as inert gas. As a result a blue emitting metal halide lamp is realized.

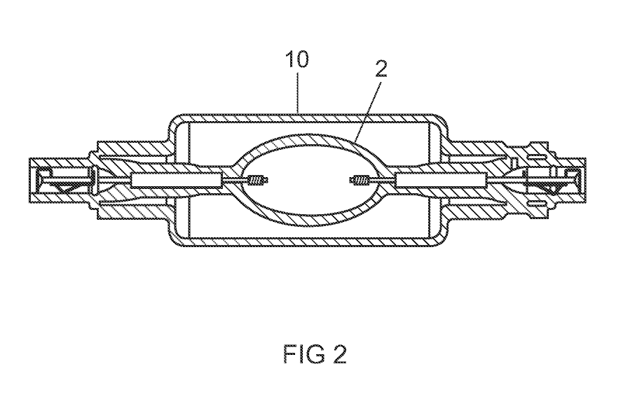

FIG. 2 shows a second exemplary embodiment with a discharge vessel 2 made of quartz glass, to which an integrated outer bulb 10 is attached without requiring a frame. The filler is similar to in the exemplary embodiment in FIG. 1a.

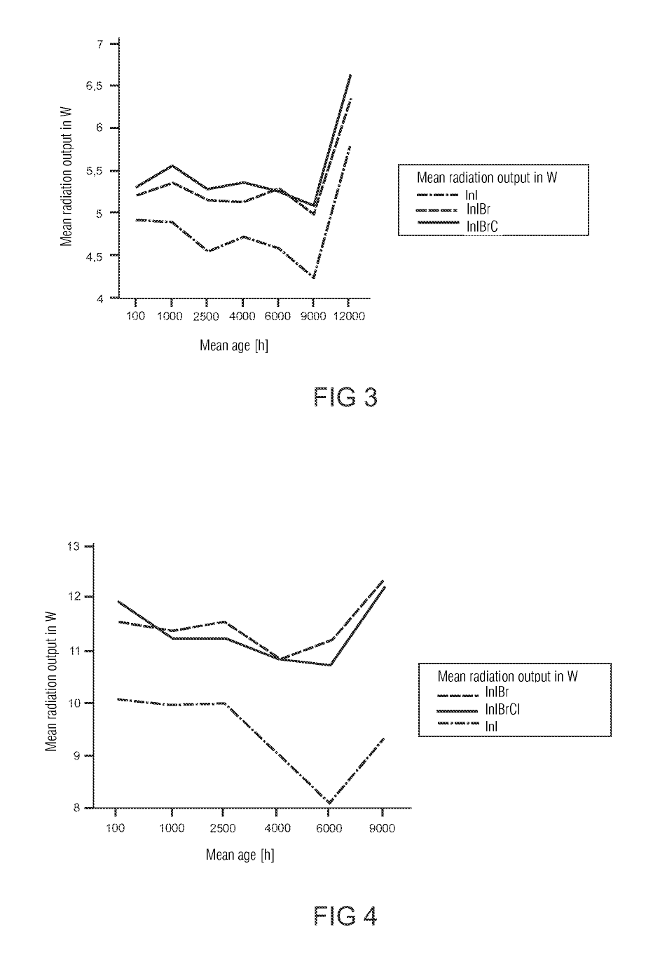

FIG. 3 shows a diagram, in which the maintenance of various fillers of In-halide was compared with one another for a 70 W lamp. This shows that pure InI (curve a) exhibits the worst behavior by some distance. The radiation output in the blue spectral range reduces from the reference point after 100 hours to up to 6000 hours to at most 80%, if mixtures are used.

By contrast, mixtures made of InI and InBr clearly indicate better values (curve b), above all if the portion of the InI lies between 25 and 75% by weight. Similarly good values are achieved if a triple mixture is used, wherein InI (50 to 80% by weight) with 10 to 20% by weight InBr and 2 to 10% by weight InCl is predominantly used (curve c).

FIG. 4 shows a diagram for 150 W lamps, in which the maintenance of a mixture of 55% by weight of TlI with 45% by weight of InBr (curve a) is compared with pure InI (curve b) and InBr (curve c) on the one hand and on the other hand with a triple mixture (curve d) comprising portions of InI (70% by weight), InBr (20% by weight) and InCl (10% by weight). It is evident that the addition of chorine must be carefully dosed. It should preferably be added in small quantities, relative to InI at most 13:1. With InBr, it should preferably be added in quantities of 1:3 to 1:6 relative to InI.

Table 1 shows the lighting-relevant data of various metal halide lamps having quartz glass bulbs according to FIGS. 1 and 2.

The filler is designed for emission in the blue spectral range within 440 to 485 nm. A lamp of this type can be used for general illumination, in particular as effect light for architectural lighting. With the new type of filler, associated with a discharge vessel made of quartz glass, a higher output is achieved in the blue spectral range, associated with a long service life, high color saturation and good maintenance. The service life amounts to at least 9000 hours, the maintenance is at least 80% and the color saturation at least 50%.

The filler contains no Na, or Sc or Tl. Only halides of In are used as metal halides. The maximum portion of the InI is 90 mol %, the minimal portion of InBr is 10 mol %. InCl with a portion up to 20 mol % may also be added to this Br/I mixture. The portion of InI preferably lies at 40 to 90 mol %, and 10 to 60 mol % InBr.

The entire fill quantity of halide of In preferably amounts to between 0.05 and 0.5 mg/ml volume of the discharge vessel. Further filler components are inert gas and argon and Hg.

For lamps up to 150 W output, the entire fill quantity of halide of In preferably amounts to between 0.09 and 0.5 mg/ml volume of the discharge vessel. For lamps from 200 W output, the entire fill quantity of halide of In preferably amounts to between 0.05 and 0.4 mg/ml volume.

TABLE 1

| | Type | | | |
|---|---|---|---|---|
| | FIG. 1 | FIG. 2 | FIG. 1 | FIG. 1 |
| | with | with | with | with |
| | 70 W | 150 W | 250 W | 400 W |
| Fill quantity: | 0.1 mg | 0.2 mg | 0.6 mg | 1.5 mg |
| 78% by weight InI + | | | | |
| 17.2% by weight InBr + | | | | |
| 4.8% by weight InCl | | | | |
| Volume | 0.7 ml | 1.8 ml | 5.2 ml | 8.0 ml |
| Color saturation at | 65% | 69% | 72% | 71% |
| 100 h | | | | |
| Radiation output in | 5.4 W | 11.5 W | 22 W | 35 W |
| the blue spectral | | | | |
| range 440 to 485 nm at | | | | |
| 100 h | | | | |
| Maintenance after | More | More | More than | More than |
| 9000 h | than 80% | than 80% | 80% | 80% |

1. A high pressure discharge lamp, comprising:
a bulb, which surrounds a discharge volume,
a filler, which contains indium halide, quicksilver and inert gas from the group neon, argon, krypton, xenon, which is accommodated in the discharge volume,
wherein the filler simultaneously contains the halide of iodine and bromine,
wherein the portion of InI amounts at most to 90 mol %, in respect of the total of all halides of In.

2. The high pressure discharge lamp as claimed in claim 1,
wherein that the portion of InI amounts to at least 25%, in particular at least 40%.

3. The high pressure discharge lamp as claimed in claim 1,
wherein the portion of InBr amounts to 10% to a maximum of 60 mol %, in respect of the total of all halides of In.

4. The high pressure discharge lamp as claimed in claim 1,
wherein the filler has portions of InCl to a maximum of 20 mol %, in respect of the total of all halides of In.

5. The high pressure discharge lamp as claimed in claim 1,
wherein the inert gas is one of argon, xenon, krypton, neon, and mixtures thereof.

6. The high pressure discharge lamp as claimed in claim 1,
wherein the cold filling pressure of the inert gas is selected in the range of 30 to 300 hPa.

7. The high pressure discharge lamp as claimed in claim 1,
wherein the content of Hg is selected in the range of 3 to 30 mg/cm³.

8. The high pressure discharge lamp as claimed in claim 1,
wherein the lamp is a color-emitting lamp for effect lighting.

9. The high pressure discharge lamp as claimed in claim 1,
wherein the fill quantity of the entire In-halide lies between 0.05 and 0.5 mg per ml discharge volume.

10. The high pressure discharge lamp as claimed in claim 1,
wherein the discharge vessel is manufactured from quartz glass.

11. The high pressure discharge lamp as claimed in claim 4,
wherein the filler has portions of InCl to a maximum of 20 mol %, in respect of the total of all halides of In, and at least 2 mol %.
